(19) United States
(12) Patent Application Publication
(10) Pub. No.: US 2006/0273052 A1
(43) Pub. Date: Dec. 7, 2006

(54) Mounting apparatus for electronic module

(75) Inventor: Hsuan-Chen Chen, Tu-cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/378,926

(22) Filed: Mar. 17, 2006

(30) Foreign Application Priority Data
Jun. 4, 2005 (CN) 200520059628.5

(51) Int. Cl. A47F 7/00; G06F 1/16

(52) U.S. Cl. 211/26; 361/724; 361/685

(57) ABSTRACT

A mounting apparatus for an electronic module includes a bracket, a first hook mounted to the electronic module, a securing member, and a resilient member. The bracket includes a bottom wall. The bottom wall defines a through hole therein. The securing member rotatably mounted to the bottom wall of the bracket includes a driving member, and a locking member. The driving member is inserted through the through hole of the bracket to be engaged in the locking member. The locking member includes a second hook, corresponding to the first hook. The resilient member is mounted between the bracket and the securing member.

### BACKGROUND

1. Field of the Invention

The present invention relates to mounting apparatuses, and particularly to a mounting apparatus readily and securely installing or removing an electronic module thereto or therefrom.

2. General Background

Generally, in the enclosure of a typical portable computer, there is a CD-ROM driver mounted therein. There are many ways to secure the CD-ROM driver in the enclosure. One way is by using screws. However, this way of securing the CD-ROM driver is unduly painstaking and time-consuming. Disassembly of the CD-ROM driver is similarly painstaking and time-consuming.

What is needed is to provide an mounting apparatus which overcomes the above-mentioned problems.

### SUMMARY

An exemplary mounting apparatus for an electronic module includes a bracket, a first hook mounted to the electronic module, a securing member, and a resilient member. The bracket includes a bottom wall. The bottom wall defines a through hole therein. The securing member rotatably mounted to the bottom wall of the bracket includes a driving member, and a locking member. The driving member is inserted through the through hole of the bracket to be engaged in the locking member. The locking member includes a second hook, corresponding to the first hook. The resilient member is mounted between the bracket and the securing member.

Other advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a mounting apparatus for electronic module in accordance with a preferred embodiment of the present invention, together with an electronic module, the mounting apparatus includes a bracket, a fixing member, and a securing member;

FIG. 2 is similar to FIG. 1, but viewed from another aspect;

FIG. 3 is an exploded, isometric view of the securing member of FIG. 1, the securing member includes a locking member, a resilient member, and a driving member;

FIG. 4 is an enlarged, isometric view of the locking member of FIG. 3, but 0viewed from another aspect;

FIG. 5 is an assembled view of FIG. 1;

FIG. 6 is an exploded, isometric view of a mounting apparatus for electronic module in accordance with an alternative preferred embodiment of the present invention, together with an electronic module, the mounting apparatus includes a bracket, a fixing member, and a securing member, the securing member includes a locking member, a resilient member, and a driving member;

FIG. 7 is an enlarged, isometric view of the locking member of FIG. 6, but viewed from another aspect; and

FIG. 8 is an assembled view of FIG. 6.

### DETAILED DESCRIPTION OF THE EMBODIMENT

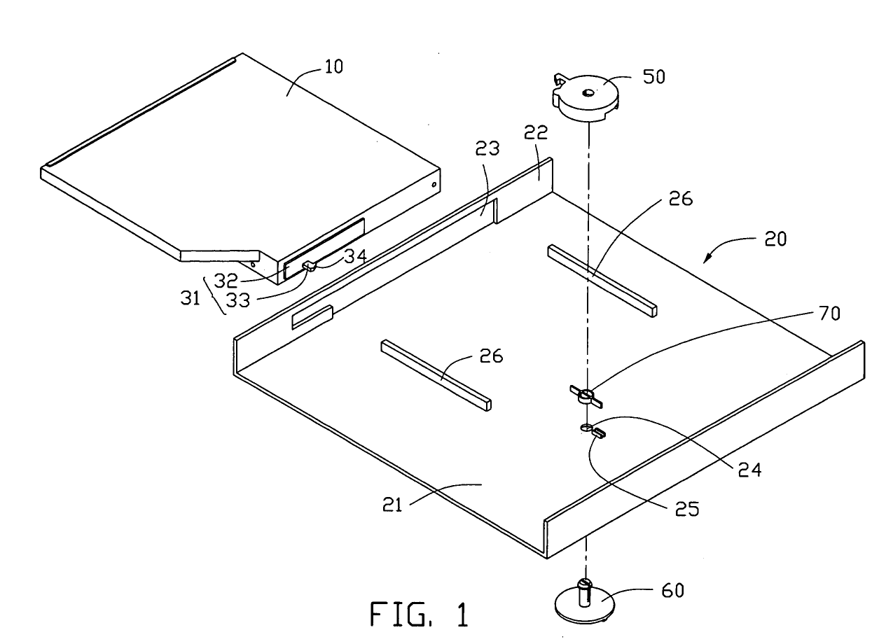

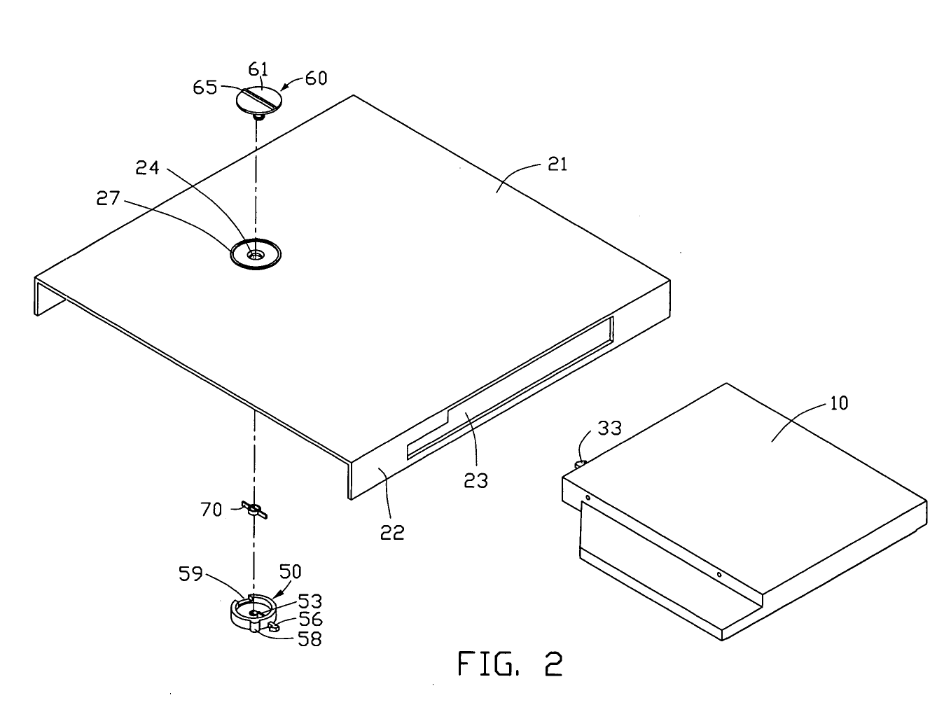

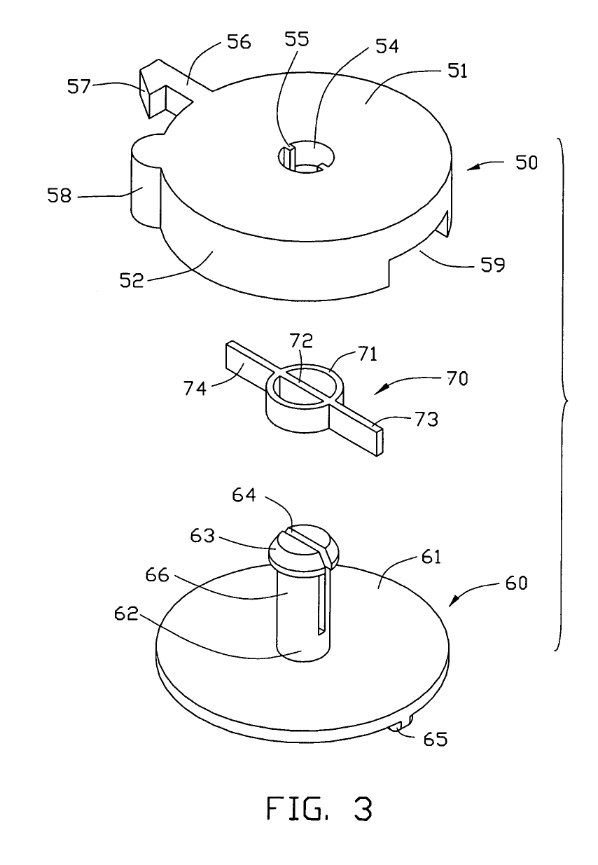

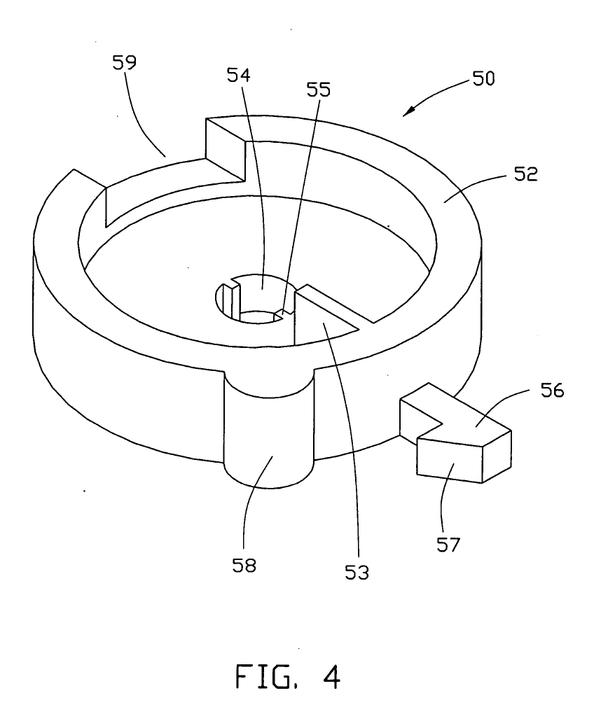

Referring to FIGS. 1 to 4, a mounting apparatus of an electronic device like a laptop in accordance with a preferred embodiment of the present invention is shown for mounting an electronic module, such as a CD-ROM driver 10 or a battery (not shown). The mounting apparatus includes a bracket 20, a fixing member 31 mounted to a rear end of the CD-ROM driver 10 used as a first engaging member, a securing member, and a resilient member 70.

The bracket 20 includes a bottom wall 21, and a sidewall 22 extending upwardly from a side of the bottom wall 21. An opening 23 is defined in the sidewall 22 for the CD-ROM driver 10 passing therethrough. The bottom wall 21 defines a through hole 24 therein opposite to the sidewall 22. A pair of orientation members 26 extends upwardly from the bottom wall 21 between the sidewall 22 and the through hole 21. A pair of location tabs 25 extends upwardly from the bottom wall 21 adjacent the through hole 24 and opposite to the orientation members 26. A ring body 27 round the through hole 24 protrudes downwardly from the bottom wall 21.

The fixing member 31 includes a mounting board 32 mounted to the rear end of the CD-ROM driver 10, and a first L-shaped hook 33 extending outwardly from the mounting board 32. The first hook 33 includes a first slanting guiding surface 34 at a distal end thereof.

The securing member rotatably mounted to the bottom wall 21 of the bracket 21 includes a locking member 50, and a rotatable driving member 60. The locking member 50 includes a circular body 51. A flange 52 extends downwardly from sides of the body 51. The body 51 defines a mounting hole 54 in a center thereof. A second L-shaped hook 56 extends outwardly from the flange 52 used as a second engaging member. The second hook 56 includes a second slanting guiding surface 57 at a distal end thereof. A semicolumn-shaped pusher 58 extends from the flange 52 adjacent the second hook 56 used as a third engaging member. A cutout 59 is defined in the flange 52 opposite to the second hook 56. A projection portion 53 extends inwardly from the flange 52 and aligns with the second hook 56. A pair of location portions 55 opposite to each other extends into the mounting hole 54 from the body 51.

The driving member 60 includes a circular base 61, a pillar 62 extends upwardly from a center of the base 61, and an operation portion 65 extends downwardly from the base 61. A barb 63 is formed at a distal end the pillar 62. A slot 64 is defined in the pillar 62 to divide a top portion of the pillar 62 into two opposite elastic clasps 66.

The resilient member 70 includes a cylinder 71 defining a through hole therein, a mounting plate 72 in the through hole of the cylinder to connect two opposite sides of the cylinder 71 along a diameter of the cylinder 71, and a pair of resilient plates 73, 74 extending outwardly from the sides of the cylinder at two ends of the mounting plate 72.

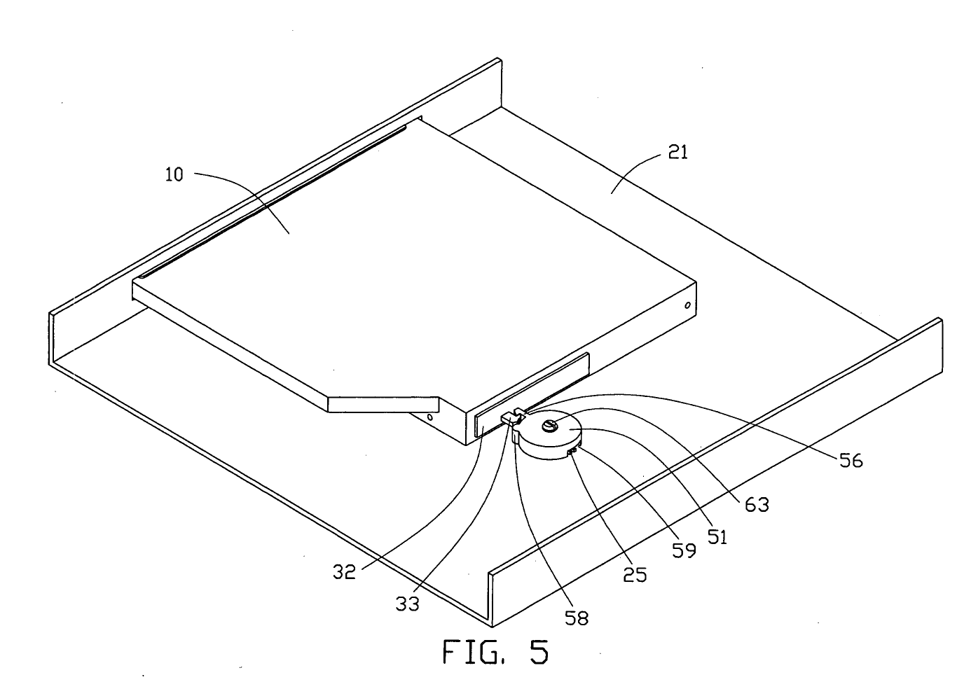

Referring also to FIG. 5, in assembly, the pillar 62 of the driving member 60 is inserted through the through hole 24 of the bracket 20 from a bottom of the bracket 20. The base 61 of the driving member 60 is received in the ring body 27 of the bracket 20. The resilient member 70 is mounted to the pillar 62 of the driving member 60 with the mounting plate 72 of the resilient member 70 being location in the slot 64, and the cylinder 71 of the resilient member 70 ringing the pillar 62. The clasps 66 hook a top of the cylinder 71 of the resilient member 70. The resilient plate 73 is located between the two location tabs 25 of the bottom wall 21 of the bracket 20. The locking member 50 is mounted to the driving member 60 and covers the resilient member 70. The pillar 62 is inserted through the mounting hole 54 and engaged with the body 51 of the locking member 50 via the clasps 63. The location portions 55 are received in the slot 64 of the driving member 60. The location tabs 25 of the bracket 20 are received in the cutout 59 of the locking member 50. The hook 56 faces to the opening 23 of the bracket 20. Thus, the mounting apparatus is formed.

In assembling the CD-ROM driver 10, the CD-ROM driver 10 is inserted into the bracket 20 through the opening 23 to slide between the two orientation members 26. The first guiding surface 34 of the first hook 33 of fixing member 31 that is mounted to the CD-ROM driver 10 slides on the second guiding surface 57 of the second hook 56 to compel the locking member 50 to rotate. The locking member 50 compels the driving member 60 to rotate together via the location portions 55 of the locking member 50. The projection portion 53 of the locking member 50 elastically deforms the resilient plate 74 of the resilient member 70. The CD-ROM driver 10 is pushed toward the securing member, till the first hook 33 of fixing member 31 that is mounted to the CD-ROM driver 10 is engaged with the second hook 56 of the locking member 50. The resilient plate 74 of the resilient member 70 is elastically restored to compel the locking member 50 to be restored. Thus, the CD-ROM driver 10 is secured to the bracket 20.

In disassembling the CD-ROM driver 10, the driving member 60 is rotated by turning the operation portion 65 thereof. The locking member 50 is rotated together with the driving member 60 via the location portions 55 of the locking member 50. The resilient plate 74 of the resilient member 70 is deformed. The second hook 56 of the locking member 50 is disengaged from the first hook 33 of the fixing member 31 that is mounted to the CD-ROM driver 10. The first hook 33 slides on the pusher 58. The pusher 58 compels the CD-ROM driver 10 to slide away from the securing member. Thus, the CD-ROM driver 10 can be extracted through the opening 23 of the bracket 20. The resilient plate 74 of the resilient member 70 is restored to compel the locking member 50 and the driving member 60 to be restored.

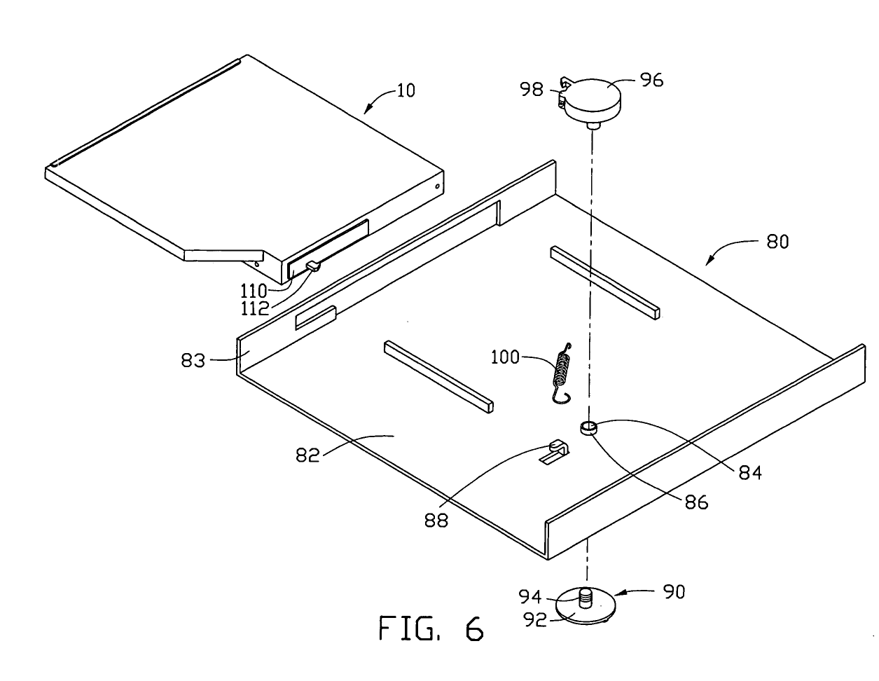

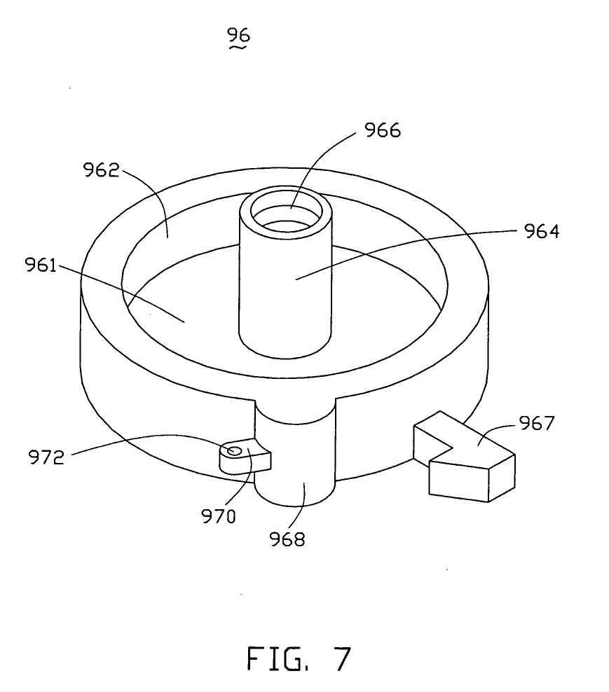

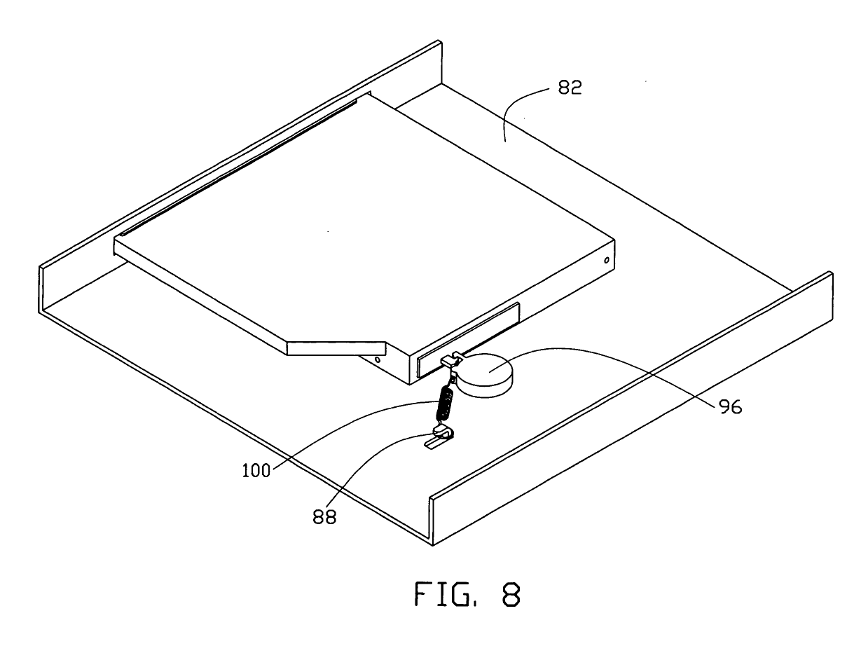

FIGS. 6 to 8 show a mounting apparatus in accordance with the alternative embodiment of the present invention. The mounting apparatus includes a bracket 80, a fixing member 110, a securing member, and a spring 100. The fixing member 110 including a first hook 112 is similar to the fixing member 31 of the above-mentioned embodiment. The bracket 80 includes a bottom wall 82, and a sidewall 83 extends upwardly from a side of the bottom wall 82. A hollow post 86 defining a through hole 84 extends upwardly from the bottom wall 82 opposite to the sidewall 83. A first hooking tab 88 extends from the bottom wall 82 adjacent the post 86. The securing member includes a driving member 90, and a locking member 96. The driving member 90 includes a base 92, and a threaded post 94 extends from a center of the base 92. The locking member 96 is similar to the locking member 50. The locking member 96 includes a circular body 961, and a flange 962 extending downwardly from sides of the body 961. A hollow sleeve 964 defining internal thread 966 extends downwardly from a center of the body 961. A second hook 967 and a semicolumn-shaped pusher 968 extend outwardly from the flange 962. A second hooking tab 970 extends from the pusher 968. A hooking hole 972 is defined in the second hooking tab 970.

In assembly, the threaded post 94 of the driving member 90 is inserted through the through hole 84 to be engaged in the sleeve 964 of the locking member 96. Two ends of the spring 100 are connected to the first hooking tab 88 of the bracket 20 and the second hooking tab 970 of the locking member 96. The principle of work of the mounting apparatus in this embodiment is similar to that of the above-mentioned embodiment.

It is believed that the present embodiments and their advantages will be understood from the foregoing description, and it will be apparent that various changes may be made thereto without departing from the spirit and scope of the invention or sacrificing all of their material advantages, the examples hereinbefore described merely being preferred or exemplary embodiments of the invention.

We claim:

1. A mounting apparatus for an electronic module, comprising:
a bracket comprising a bottom wall, the bottom wall defining a through hole therein;
a first hook mounted to the electronic module;
a securing member rotatably mounted to the bottom wall of the bracket comprising a driving member, and a locking member, the driving member being inserted through the through hole of the bracket to be engaged in the locking member; the locking member comprising a second hook, corresponding to the first hook; and
a resilient member mounted between the bracket and the securing member.

2. The mounting apparatus as claimed in claim 1, wherein the bracket further comprises a sidewall extending from a side of the bottom wall, the sidewall defines an opening for the electronic module passing therethrough.

3. The mounting apparatus as claimed in claim 1, wherein the locking member comprises a body, and a flange extending from sides of the body, the second hook extends from the flange.

4. The mounting apparatus as claimed in claim 3, wherein the first hook comprises a first slanting guiding surface, the second hook comprises a second slanting guiding surface, corresponding to the first guiding surface.

5. The mounting apparatus as claimed in claim 4, wherein a pusher protrudes from the flange of the locking member adjacent the second hook.

6. The mounting apparatus as claimed in claim 5, wherein the pusher has a semicolumn shape.

7. The mounting apparatus as claimed in claim 3, wherein the body of the locking member defines a mounting hole therein, the driving member comprises a base, and a pillar extending upwardly from the base and rotatably received in the through hole of the bracket, the pillar is engaged in the mounting hole of the locking member.

8. The mounting apparatus as claimed in claim 7, wherein a pair of location portions opposite to each other extends from the locking member into the mounting hole, a barb is formed at a distal end of the pillar, a slot is defined in the pillar to divide a top portion of the pillar into two elastic clasps for clasping the locking member, the location portions of the locking member are received in the slot of the pillar.

9. The mounting apparatus as claimed in claim 7, wherein one end of the resilient member is located to the bottom wall of the bracket, the resilient member comprises a resilient plate, the locking member comprises a projection portion extending inwardly from the flange thereof, corresponding to the resilient plate.

10. The mounting apparatus as claimed in claim 9, wherein the resilient member mounted between the driving member and the locking member further comprises a cylinder defining a through hole therein, a mounting plate is formed in the through hole of the cylinder to be engaged in the slot of the pillar of the driving member.

11. The mounting apparatus as claimed in claim 10, wherein a resilient plate extends from the cylinder, a pair of location tabs extends from the bottom wall of the bracket for location the resilient plate.

12. A mounting apparatus for an electronic module that has a first hook mounted thereto, comprising:
a bracket comprising a bottom wall;
a securing member rotatably mounted to the bottom wall of the bracket comprising a second hook, corresponding to the first hook; and
a resilient member connected to the bracket and the securing member.

13. The mounting apparatus as claimed in claim 12, wherein the first hook comprises a first slanting guiding surface, the second hook comprises a second slanting guiding surface, corresponding to the first guiding surface.

14. The mounting apparatus as claimed in claim 13, wherein the securing member comprises a locking member, and a driving member, a sleeve defining internal thread therein extends downwardly from the locking member, a threaded post extends upwardly from the driving member to be engaged in the sleeve.

15. The mounting apparatus as claimed in claim 14, wherein a through hole is defined in the bottom wall of the bracket, the threaded post of the driving member is inserted through the through hole to be engaged in the sleeve.

16. The mounting apparatus as claimed in claim 15, wherein a pusher protrudes from the flange of the locking member adjacent the second hook.

17. The mounting apparatus as claimed in claim 16, wherein the resilient member comprises a spring connected to the bottom wall of the bracket and the locking member of the securing member.

18. An electronic device comprising:
a bracket installable in said electronic device, and defining an opening along a side thereof as an access into said bracket;
an electronic module removably installable in said electronic device, and movably receivable in said bracket through said opening of said bracket, said electronic module comprising a first engaging member extending therefrom; and
a securing member movably installable beside said bracket and comprising a second engaging member and a third engaging member extending therefrom in said bracket, engagement between said first and second engaging members enabling retention of said electronic module in said bracket when said electronic module entirely moves into said bracket, and engagement between said first and third engaging members enabling retreat movement of said electronic module out of said bracket through said opening of said bracket.

19. The electronic device as claimed in claim 18, wherein said securing member is rotatable relative to said bracket to movably enable a selective one of said engagement between said first and second engaging members, and said engagement between said first and third engaging members when said securing member rotates to a preset rotary position thereof.
